(19) United States
(12) Patent Application Publication
(10) Pub. No.: US 2026/0295415 A1
(43) Pub. Date: Oct. 1, 2026

(54) GAME SYSTEM, INFORMATION PROCESSING METHOD, AND COMPUTER-READABLE MEDIUM

(71) Applicant: Nintendo Co., Ltd., Kyoto (JP)

(72) Inventors: Yasutaka TAKEUCHI, Kyoto (JP); Yoshito UEYAMA, Kyoto (JP)

(21) Appl. No.: 19/631,726

(22) Filed: Mar. 27, 2026

(30) Foreign Application Priority Data
Mar. 28, 2025 (JP) 2025-055822

(51) Int. Cl. A63F 13/5375; A63F 13/5378; A63F 13/54; A63F 13/56

(52) U.S. Cl. CPC A63F 13/5375; A63F 13/5378; A63F 13/54; A63F 13/56

(57) ABSTRACT

An example of a game system of an exemplary embodiment includes a game apparatus, a server, and a communication terminal. The game apparatus moves a player character within a three-dimensional virtual space based on an operation input. The communication terminal displays a first map and destination point candidates and determines a destination point from among the candidates based on an operation input. Based on a destination in the three-dimensional virtual space corresponding to the determined destination point and three-dimensional position information of the player character, the game apparatus calculates a distance or direction to the destination and transmits first guidance information. The communication terminal outputs a guidance display or a guidance voice based on the first guidance information or second guidance information corresponding to the first guidance information.

### CROSS REFERENCE TO RELATED APPLICATION

This application claims priority to Japanese Patent Application No. 2025-055822, filed on Mar. 28, 2025, the entire contents of which are incorporated herein by reference.

### FIELD

The technique shown here relates to a game system, an information processing method, and a game program for controlling the movement of a player character.

### BACKGROUND AND SUMMARY

Conventionally, there are games in which a map of a virtual space is displayed in order to make it easier for a user to cause a player character to reach a destination.

However, there has been room for improvement in making it easier for the user to cause the player character to reach the destination.

An exemplary embodiment discloses a new game system, a new information processing method, and a new game program for making it easier for a user to cause a player character to reach a destination.

An exemplary embodiment adopts the following examples.

### First Example

A first example is a game system including a game apparatus and a communication terminal each capable of communicating with a server. The game apparatus is configured to perform movement control for moving a player character within a three-dimensional virtual space, based on an operation input. The communication terminal includes a display and a speaker and is configured to store a two-dimensional first map corresponding to the three-dimensional virtual space, display the first map and destination point candidates on the display, determine a destination point from among the candidates based on an operation input, and transmit the determined destination point to the server. The game apparatus is configured to acquire the destination point from the server, calculate, based on a destination in the three-dimensional virtual space corresponding to the destination point acquired from the server and three-dimensional position information of the player character within the three-dimensional virtual space, a distance or direction from the player character to the destination, determine first guidance information based on the calculated distance or direction from the player character to the destination, and transmit the first guidance information to the server. The communication terminal is configured to acquire the first guidance information or second guidance information corresponding to the first guidance information, from the server, and output a guidance display from the display or a guidance voice from the speaker based on the first guidance information or the second guidance information acquired from the server.

According to the above, a user can set a destination using the first map displayed on the communication terminal, and by operating the game apparatus based on the guidance display or guidance voice from the communication terminal, cause the player character to reach the destination, thereby providing a new guidance method.

### Second Example

In a second example based on the first example, the three-dimensional virtual space may include a first field and a second field located above or below the first field. The first map may include a map indicating map information of the first field and a map indicating map information of the second field.

According to the above, guidance to the destination can be performed using a map provided for each field.

### Third Example

In a third example based on the second example, the communication terminal may be configured to: determine the destination point on the first field or the second field based on an operation input; output, as the guidance display or the guidance voice, first guidance indicating a distance or direction to the destination, if the destination is on the first field when the player character is located on the first field; and output, as the guidance display or the guidance voice, second guidance indicating that the destination is on the second field, if the destination is on the second field when the player character is located on the first field.

According to the above, if the destination is on a field different from the field on which the player character is located, guidance to the field can be performed, and if the destination is on the field on which the player character is located, specific guidance to the destination can be performed.

### Fourth Example

In a fourth example based on any one of the first to third examples, the game apparatus may be configured to: store a two-dimensional second map corresponding to the first map and indicating map information of a field in the three-dimensional virtual space; display the second map in a first state including first map information or the second map in a second state not including the first map information, based on an operation input; and change the second map from the second state to the first state in accordance with the player character reaching the destination or a specified condition being satisfied at the destination. The first map may include second map information corresponding to the first map information of the second map regardless of whether the second map is in the first state or the second state. The communication terminal may be configured to display the first map including the second map information and position information of the player character, on the display.

According to the above, even in a state where the second map displayed on the game apparatus does not include the first map information, the first map displayed on the communication terminal includes the second map information, and therefore guidance to the destination can be performed using the communication terminal.

### Fifth Example

In a fifth example based on any one of the first to fourth examples, the communication terminal may be configured to determine a second-type destination point from the candidates based on an operation input, and transmit the determined second-type destination point to the server. The game apparatus may be configured to acquire the second-type destination point from the server, and transmit identification information corresponding to the second-type destination, to the server if the player character reaches a second-type destination in the three-dimensional virtual space corresponding to the second-type destination point acquired from the server. The communication terminal may be configured to output a voice content corresponding to the identification information, from the speaker.

According to the above, since the voice content corresponding to the second-type destination is output when the player character reaches the second-type destination, the user can be provided with a sense of enjoyment upon reaching the destination.

### Sixth Example

In a sixth example based on the fifth example, the game apparatus may be configured to calculate a distance or direction from the player character to the second-type destination in the three-dimensional virtual space based on the second-type destination and the position information, determine the first guidance information based on the calculated distance or direction from the player character to the second-type destination, and transmit the first guidance information to the server.

According to the above, guidance to the second-type destination can also be performed.

### Seventh Example

In a seventh example based on any one of the first to sixth examples, the communication terminal may be configured to acquire voice data as the second guidance information, and output the guidance voice based on the acquired voice data.

According to the above, the data capacity of the communication terminal can be reduced.

Another example may be an information processing method performed in the above game system or may be one or more non-transitory computer-readable media having stored therein instructions executable in the above game apparatus.

According to an exemplary embodiment, it is possible to provide a new guidance method.

These and other objects, features, aspects and advantages of an exemplary embodiment will become more apparent from the following detailed description when taken in conjunction with the accompanying drawings.

### BRIEF DESCRIPTION OF THE DRAWINGS

FIG. 1 shows an example of a game system 1 according to an exemplary embodiment;

FIG. 2 shows an example of the configuration of a game apparatus 20;

FIG. 3 shows an example of the configuration of a smartphone 30;

FIG. 4 shows an example of a game screen when a game of an exemplary embodiment is being executed on the game apparatus 20;

FIG. 5 shows an example of a screen of the smartphone 30 during execution of a guidance function;

FIG. 6 shows an example of a destination setting screen and shows an example of an application screen when a user selects an icon I41 of a first game object 41;

FIG. 7 shows an example of the application screen immediately after the start of guidance to the first game object 41;

FIG. 8 shows an example of the game screen after a player character PC has moved northward from a position shown in FIG. 4;

FIG. 9 shows an example of the application screen during guidance when the game screen shown in FIG. 8 is being displayed;

FIG. 10 shows an example of the game screen when the player character PC has further moved northward and has reached the vicinity of a destination DP;

FIG. 11 shows an example of the application screen when the game screen shown in FIG. 10 is being displayed;

FIG. 12 shows an example of a second map displayed on the game screen and shows a state where an area related to the first game object 41 in a ground field GF changes from an unopened state to an opened state;

FIG. 13 shows a flow of operations of the game apparatus 20, a server 10, and the smartphone 30 when guidance to the first game object 41 is performed;

FIG. 14 shows an overview of the flow of guidance to a second game object 42;

FIG. 15 shows an example of various data stored in the game apparatus 20;

FIG. 16 shows an example of various data stored in the smartphone 30;

FIG. 17 shows an example of various data stored in the server 10;

FIG. 18 is a flowchart showing an example of a game apparatus process performed in the game apparatus 20;

FIG. 19 is a flowchart showing an example of a guidance process in step S19;

FIG. 20 is a flowchart showing an example of a smartphone process performed in the smartphone 30; and

FIG. 21 is a flowchart showing an example of a server process performed in the server 10.

### DETAILED DESCRIPTION OF NON-LIMITING EXAMPLE EMBODIMENTS

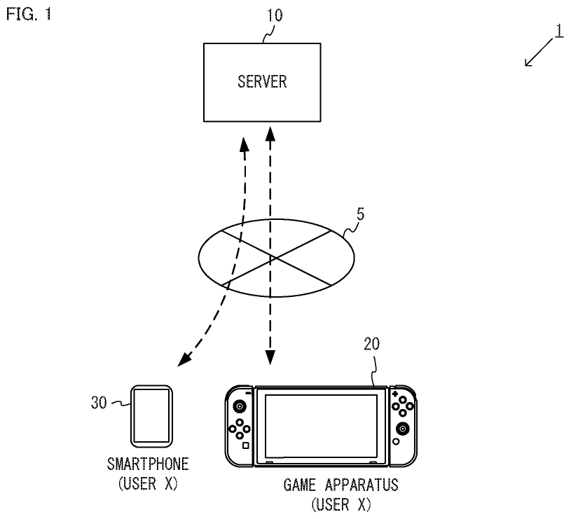

Hereinafter, a game system according to an example of an exemplary embodiment will be described. FIG. 1 shows an example of a game system 1 of an exemplary embodiment. As shown in FIG. 1, the game system 1 includes a server 10, a game apparatus 20, and a smartphone 30. The game apparatus 20 is communicably connected to the server 10 via a network 5 (for example, the Internet). In addition, the smartphone 30 is communicably connected to the server 10 via the network 5.

The server 10 is composed of one or more server devices. The server 10 includes a processor (not shown), a storage device, and a communication processor including one or more processors. Account information of each user, voice data described later, etc., are stored in the server 10.

The game apparatus 20 is capable of executing various information processing programs including a game program for executing a game application of an exemplary embodiment (hereinafter simply referred to as “game”).

The smartphone 30 is capable of executing an application corresponding to the game executed on the game apparatus 20 (hereinafter referred to as “smartphone application”). The smartphone 30 may be any communication terminal such as a smart device, a tablet terminal, a personal computer, or a wearable device.

The game apparatus 20 and the smartphone 30 are used by, for example, a user X, and are associated with an account of the user X. The game system 1 includes game apparatuses 20 and smartphones 30 that are used by a large number of users.

### (Configuration of Game Apparatus 20)

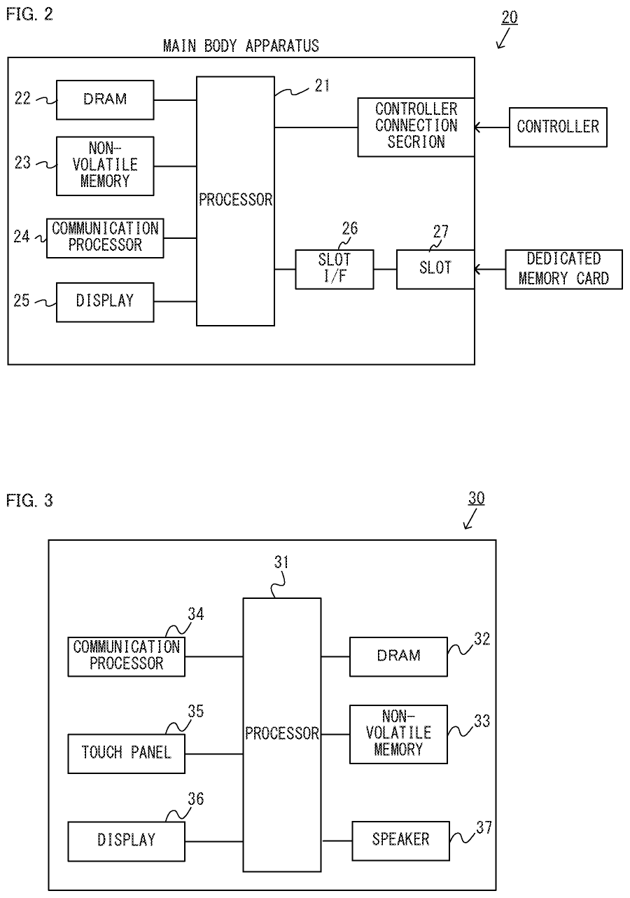

Hereinafter, an example of a configuration of the game apparatus 20 will be described. FIG. 2 shows an example of a configuration of the game apparatus 20. The game apparatus 20 of an exemplary embodiment includes a main body apparatus and a controller.

The game apparatus 20 includes a controller operated by the user. The controller is provided with a plurality of buttons for performing game operations and an analog stick for performing directional input operations. The controller is connected to the main body apparatus via a controller connection section, which is provided to the main body apparatus of the game apparatus 20, in a wired or wireless manner.

The game apparatus 20 includes a processor 21, a DRAM 22, and a non-volatile memory 23. The processor 21 includes one or more processors that execute various types of information processing (for example, game processing) executed in the game apparatus 20, and includes, for example, one or more CPUs (Central Processing Units) and one or more GPUs (Graphics Processing Units). The processor 21 may be composed of only a CPU, or may be composed of an SoC (System-on-a-chip) that includes a plurality of functions such as CPU functions and GPU functions. The processor 21 reads a game program stored in the non-volatile memory 23 or a non-transitory storage medium such as a dedicated memory card connected to a slot, loads the game program into the DRAM 22, and executes the game program.

The game apparatus 20 also includes a slot interface (hereinafter abbreviated as “I/F”) 26 and a slot 27. A dedicated non-volatile memory for the game apparatus 20 or a similar information processing apparatus (hereinafter referred to as “dedicated memory card”) can be inserted into the slot 27. In the dedicated memory card, a game program for executing a game and data to be used during execution of the game are stored. In response to instructions from the processor 21, the slot I/F 26 reads data from and writes data to the dedicated memory card inserted in the slot 27.

The game apparatus 20 also includes a display 25. The display 25 displays images generated by the game apparatus 20. The display 25 may be any type of display device, such as a liquid crystal display (LCD) or an organic EL display.

The game apparatus 20 also includes a communication processor 24. The communication processor 24 is connected to the processor 21. The communication processor 24 performs wired or wireless communication with an external device via the network 5.

In addition to the elements shown in FIG. 2, the game apparatus 20 also includes a battery for supplying power and an output terminal for outputting images and audio to an external display device (such as a television) different from the display 25.

### (Configuration of Smartphone 30)

Next, an example of a configuration of the smartphone 30 will be described. FIG. 3 shows an example of a configuration of the smartphone 30.

The smartphone 30 of an exemplary embodiment is a known smartphone and includes, for example, a processor 31, a DRAM 32, a non-volatile memory 33, a communication processor 34, a touch panel 35, a display 36, and a speaker 37.

The processor 31 executes various applications including the smartphone application of an exemplary embodiment, using the DRAM 32. The non-volatile memory 33 stores therein various application programs and data. The communication processor 34 performs wireless communication with an external device via a network.

The touch panel 35 is provided on the display 36 and detects touch operations performed by the user. The display 36 is a display device for displaying images generated by the processor 31. The speaker 37 outputs, for example, audio based on guidance information described later.

### (Overview of Game)

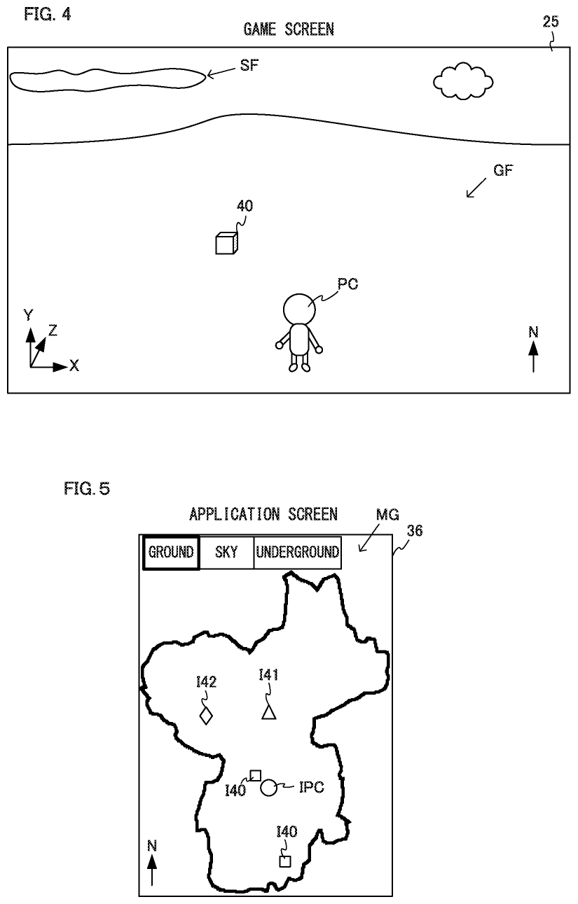

Next, an overview of the game executed on the game apparatus 20 will be described. FIG. 4 shows an example of a game screen when the game of an exemplary embodiment is being executed on the game apparatus 20.

As shown in FIG. 4, a player character PC operated by the user is placed in a three-dimensional virtual space (game space). An XYZ orthogonal coordinate system is defined in the virtual space. The X-axis is a horizontal axis, the Y-axis is an upward axis, and the Z-axis is an axis perpendicular to both the X-and Y-axes. For the virtual space, directions are set, and, for example, the Z-axis is parallel to the north direction. An image indicating the directions may be displayed on the game screen.

The virtual space in which the game of an exemplary embodiment is played has a plurality of fields that are generally planes parallel to the XZ plane. Each field may have undulations in the up-down direction. For example, the virtual space includes a ground field GF, a sky field SF that exists above the ground field GF (in the Y-axis positive direction), and an underground field (not shown) that exists below the ground field GF (in the Y-axis negative direction). For example, the sky field SF exists directly above a specified area of the ground field GF. For example, when the player character PC reaches a first location in the ground field GF, the player character PC moves to the sky field SF. When the player character PC reaches a second location in the ground field GF, the player character PC moves to the underground field. The user progresses the game while moving the player character PC on the plurality of fields. In addition to the above, the virtual space may further include other fields (e.g., a water-surface field such as sea, and a seabed field).

Various game objects that affect the progress of the game are also placed in the virtual space. For example, as a game object, an item 40 that the player character PC can equip or use is placed. When the player character PC moves to the vicinity of the item 40, the player character PC acquires the item 40. The player character PC may use or equip the acquired item. Various characters, such as enemy characters and ally characters controlled by the processor 21, are also placed in the virtual space as game objects. When the player character PC encounters these characters, the player character PC and the characters interact with each other based on operations performed by the user. For example, when the player character PC encounters an enemy character, the player character PC enters into combat with the enemy character. When the player character PC encounters a specified character, the player character PC speaks to that character. Furthermore, various architectural objects, such as shrines, towers, and monuments, are placed in the virtual space as game objects, and the player character PC reaches these architectural objects. The game progresses when the player character PC reaches a specified architectural object.

As described above, in the game of an exemplary embodiment, the game progresses as the player character PC moves through the three-dimensional virtual space, acquire various items, encounters various characters, and reaches various locations.

A game object has a first state and a second state, and when the player character PC moves to the vicinity of the game object and a specified operation is performed, the state of the game object changes. For example, when the player character PC moves to the vicinity of an item and a specified operation is performed, the item changes from a first state in which the item has not been acquired by the player character PC to a second state in which the item has been acquired by the player character PC, and disappears from the specified location. Further, when the player character PC reaches an architectural object and a specified operation is performed, the architectural object changes from a first state (a state where the player character PC has not visited the architectural object) to a second state (a state where the player character PC has visited the architectural object).

In an exemplary embodiment, in order to make it easier for the user to search for game objects placed at various locations in the virtual space, a guidance function for guiding the user to the positions of the game objects is provided. Specifically, the guidance function of an exemplary embodiment is implemented by the server 10, the game apparatus 20, and the smartphone 30. The guidance function will be described below.

### (Guidance to Game Objects Using Smartphone)

FIG. 5 shows an example of the screen of the smartphone 30 during execution of the guidance function.

In the following, an image displayed on the display 25, or on the screen of an external display device connected to the game apparatus 20, when the game is being executed on the game apparatus 20, is referred to as “game screen”. An image displayed on the display 36 of the smartphone 30 when the smartphone application is being executed is referred to as “application screen”.

As shown in FIG. 5, a two-dimensional map (hereinafter referred to as “first map”) is displayed on the application screen. The first map includes, for example, a map image MG indicating the entirety or a portion of the ground field GF. By operating one of buttons “Ground”, “Sky”, and “Underground” displayed on the application screen, the user can display a map image corresponding to the field associated with the operated button. By default, a map image corresponding to the field on which the player character PC is currently located is displayed. The upward direction in FIG. 5 corresponds to the north direction (Z-axis direction) in the virtual space, and the right direction in FIG. 5 corresponds to the east direction (X-axis direction) in the virtual space.

The map image MG includes map information. The map information includes terrain information, which is an image representing terrains formed on the ground field GF, such as mountains, rivers, lakes, grasslands, and roads. In the drawing, these pieces of the terrain information are omitted for simplicity.

As the map information, an icon IPC indicating the position of the player character PC, and a plurality of icons I40 each indicating an item 40 are displayed on the map image MG. In addition, one or more icons I41 each indicating a first game object 41 and one or more icons I42 each indicating a second game object 42 are displayed on the map image MG. In addition to these, icons indicating various game objects placed in the three-dimensional virtual space are also displayed on the map image MG.

The first game object 41 may be, for example, an item different from the item 40, or may be a character, or may be an architectural object. The second game object 42 is an object different from the first game object 41 and may be, for example, an architectural object related to a specific location.

The position (XZ coordinate values) of the icon IPC on the map image MG corresponds to the position (XZ coordinate values) of the player character PC in the three-dimensional virtual space. The same applies to the positions of the icons (I40 to I42) of the respective game objects on the map image MG.

The icons of the respective game objects on the map image MG serve as destination candidates. The user can select at least one of the icons of the multiple game objects on the application screen and set the position of the game object corresponding to the selected icon as a destination. When the user selects an icon indicating a game object, the state of the game object may be displayed. In addition, the user may search for only the icons of a designated type of game objects among all game objects that exist in the virtual space, select at least one of one or more found icons, and set the selected icon as a destination.

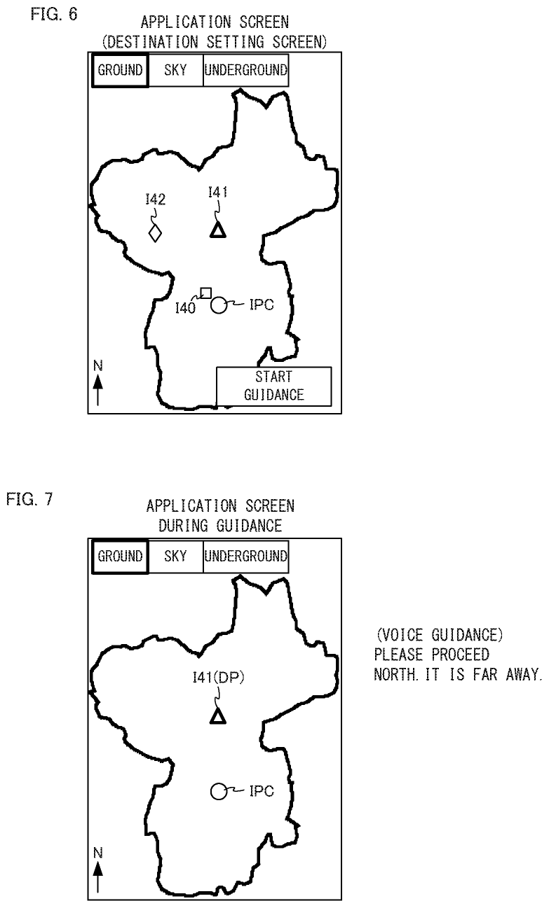

FIG. 6 shows an example of a destination setting screen and shows an example of the application screen when the user selects the icon I41 of the first game object 41. As shown in FIG. 6, when the user selects the icon I41 of the first game object 41, the display form of the selected icon I41 changes. In a state where the icon I41 is selected, when the user operates a “Start Guidance” button, the smartphone 30 starts guidance with the position of the first game object 41 as a destination DP.

FIG. 7 shows an example of the application screen immediately after the start of the guidance to the first game object 41. When the guidance is started, for example, voice guidance indicating the direction and distance from the current position of the player character PC to the destination DP is output from the speaker 37 of the smartphone 30. For example, a voice such as “Please proceed north. It is far away.” is output as the voice guidance. Following this voice guidance, the user operates the controller of the game apparatus 20 to move the player character PC within the virtual space. When the player character PC moves within the virtual space, the position of the icon IPC of the player character PC on the map image MG also changes on the smartphone screen. In addition to (or instead of) the voice guidance, image guidance (image or text) indicating the direction or distance from the position of the player character PC to the destination DP may be displayed on the application screen.

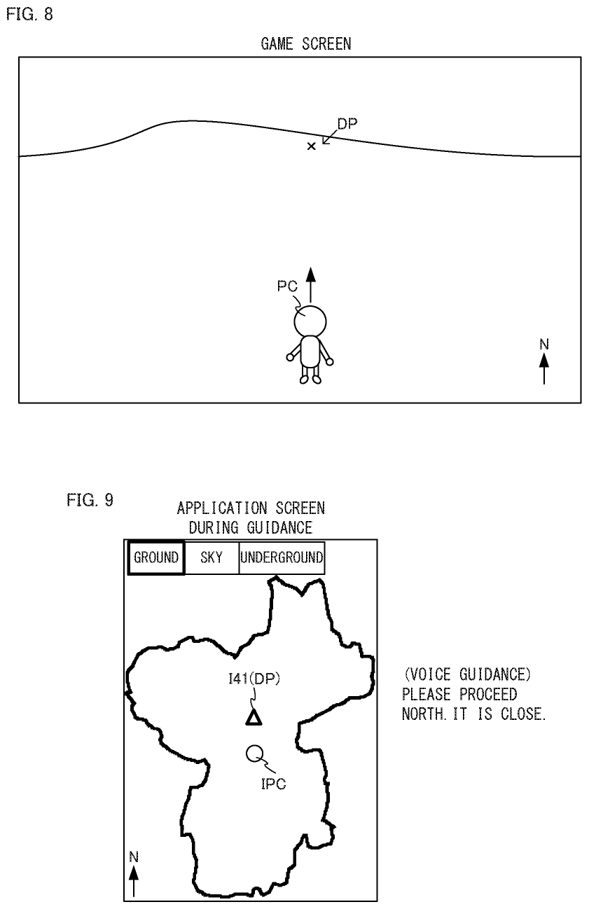

FIG. 8 shows an example of the game screen after the player character PC has moved northward from the position shown in FIG. 4. FIG. 9 shows an example of the application screen during guidance when the game screen shown in FIG. 8 is being displayed.

As shown in FIG. 8, the destination DP (the first game object 41) is displayed at a position relatively distant in the movement direction of the player character PC. The first game object 41 indicating the destination DP may not necessarily be displayed on the game screen. For example, the first game object 41 may be buried in the ground in the virtual space or placed inside another object, and therefore may not necessarily be displayed on the game screen.

When the game screen shown in FIG. 8 is being displayed, as shown in FIG. 9, the distance between the icon IPC and the destination DP becomes shorter than in FIG. 7, and for example, voice guidance such as “Please proceed north. It is close.” is output.

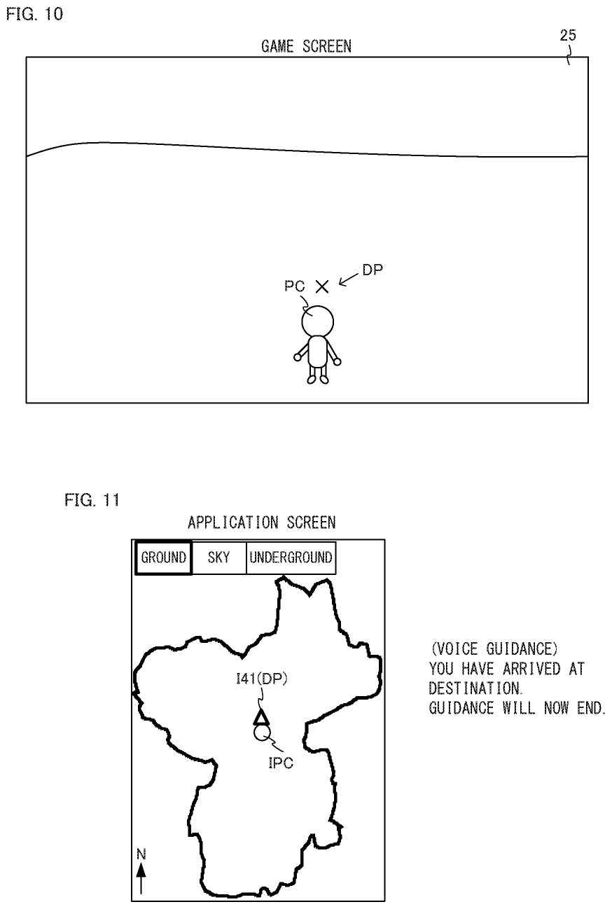

When the player character PC further moves northward from the state shown in FIG. 9, the player character PC moves closer to the destination DP. FIG. 10 shows an example of the game screen when the player character PC has further moved northward and has reached the vicinity of the destination DP. FIG. 11 shows an example of the application screen during guidance when the game screen shown in FIG. 10 is being displayed.

As shown in FIG. 10, the player character PC has further moved northward from the position shown in FIG. 8 and is located in the vicinity of the destination DP. In this case, as shown in FIG. 11, the smartphone 30 outputs, for example, a voice such as “You have arrived at your destination. Ending guidance”, and the guidance to the first game object 41 ends.

As described above, in the smartphone 30, the guidance to the first game object 41 which is set as the destination is performed using voice and/or images.

In the game apparatus 20, a two-dimensional map (hereinafter referred to as “second map”) including map information of the fields in the three-dimensional virtual space is stored. The second map corresponds to the first map displayed on the above application screen. The user can open the second map on the game screen to check the position of the player character PC and the positions of the game objects within the virtual space.

The second map includes areas in an unopened state not including map information, and areas in an opened state including map information. For example, the field is divided into a plurality of areas, and the map information of each area in the second map is initially in the unopened state. When a specified condition in the game is satisfied, an area in the unopened state is opened, and the map information of that area becomes displayed on the second map. For example, when the player character PC reaches the position of a specific game object placed in an area that is in the unopened state and a specified operation is performed by the user (or a specified action is performed by the player character PC), that area transitions to the opened state. For example, when the player character PC reaches the position of the above first game object 41 and the user performs a specified operation, the area related to the first game object 41 changes to the opened state, and the map information of that area becomes displayed on the second map.

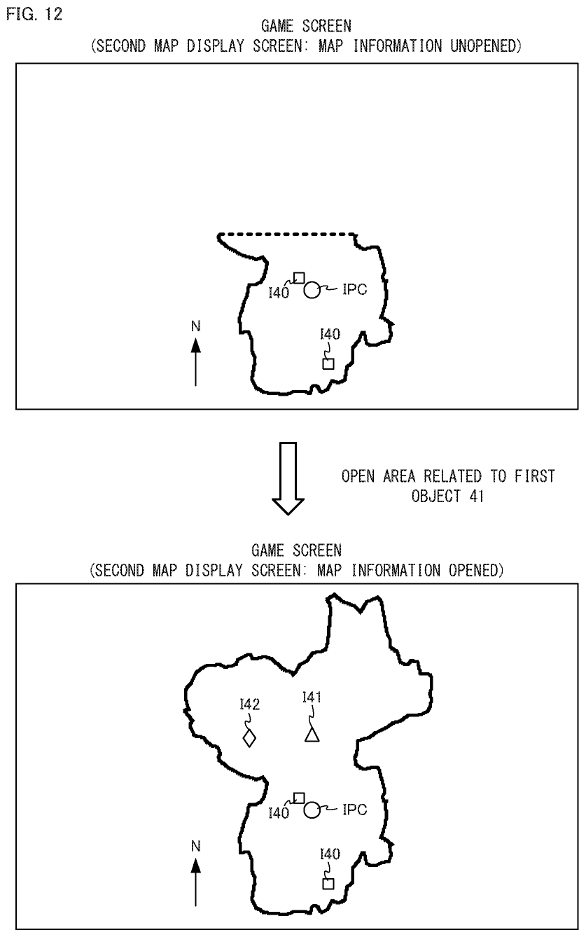

FIG. 12 shows an example of the second map displayed on the game screen, and shows a state where the area related to the first game object 41 in the ground field GF changes from the unopened state to the opened state. In the upper diagram of FIG. 12, the area related to the first game object 41 is in the unopened state, and neither the terrain information of that area nor the map information regarding game objects included in that area is displayed. When the player character PC reaches the position of the first game object 41 and a specified operation is performed, the area related to the first game object 41 transitions to the opened state as shown in the lower diagram of FIG. 12. Specifically, the terrain information of the area related to the first game object 41 and the map information regarding the game objects included in that area are displayed.

On the application screen of the smartphone 30, all map information within the field (including the terrain information and the position information of each game object) is displayed regardless of whether the map information of each area in the second map displayed on the game apparatus 20 is in the unopened state or the opened state.

As described above, the user can reach the position of a desired object within the virtual space through the guidance performed by the smartphone 30. In the second map displayed on the game apparatus 20, the map information of areas in the unopened state is not displayed; however, in the first map displayed on the smartphone 30, the map information of all areas in the field is displayed regardless of whether each area is in the opened state. Therefore, by using the first map displayed on the smartphone screen, the user can reach the position of a desired object more easily than when using only the second map displayed on the game screen.

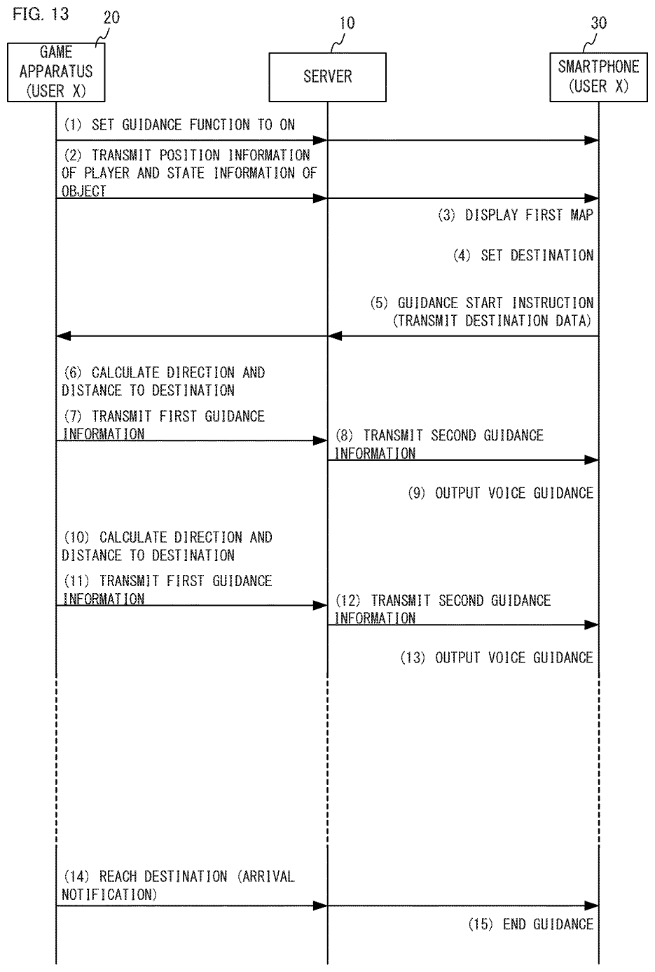

Next, an overview of the operations of the respective apparatuses included in the game system 1 when the guidance to the first game object 41 is performed will be described. FIG. 13 shows the flow of operations of the game apparatus 20, the server 10, and the smartphone 30 when the guidance to the first game object 41 is performed.

As shown in FIG. 13, first, the user sets the guidance function to ON in the game apparatus 20 (1). Information regarding this setting is transmitted to the server 10, and then transmitted from the server 10 to the smartphone 30.

When the guidance function is set to ON, the game apparatus 20 transmits the position information of the player character PC corresponding to the user, and the state information of each game object, to the server 10 (2). Thereafter, the game apparatus 20 periodically transmits the position information of the player character PC and the state information of each game object to the server 10. Specifically, the game apparatus 20 transmits the current three-dimensional position information of the player character PC in the virtual space to the server 10. The game apparatus 20 also transmits identification information for identifying each of all game objects placed in the virtual space, and state information indicating the state of each of these game objects, to the server 10. The server 10 has stored, in advance, the identification information and the position information (initial position information) of each game object placed in the virtual space in association with one another. Based on the information received from the game apparatus 20, the server 10 transmits the two-dimensional position information of the player character PC, the state information of each game object, and the two-dimensional position information of each game object to the smartphone 30. The three-dimensional position information of each game object may be transmitted from the game apparatus 20 to the server 10 and stored in the server 10.

Next, the smartphone 30 displays the first map based on the information received from the server 10 (3). Specifically, the smartphone 30 displays the map image corresponding to the field on which the player character PC is currently located, and displays the icon IPC at the position on the map image corresponding to the position of the player character PC in the virtual space. The smartphone 30 updates the position of the icon IPC of the player character PC on the map image based on the periodically received position information of the player character PC. The smartphone 30 also displays, at positions on the map image corresponding to the positions of the game objects in the virtual space, icons indicating the game objects. Based on the periodically received state information of each game object, the smartphone 30 may update the display form of the icon corresponding to each game object. The smartphone 30 selects and displays one of map images respectively corresponding to the plurality of fields based on an input by the user. By default, the map image corresponding to the field on which the player character PC is currently located is displayed.

Next, the user sets a destination by selecting one of the icons indicating the multiple game objects displayed on the map image (4). The user then operates the “Start Guidance” button. In response to this operation, the smartphone 30 transmits a guidance start instruction to the server 10 (5). This guidance start instruction includes destination data indicating the destination. The destination data is, for example, the identification information of the game object that is set as the destination. The destination data may be the position information of the game object. The server 10 transmits the destination data to the game apparatus 20.

Next, the game apparatus 20 receives the destination data and calculates the direction and distance from the current position of the player character PC to the destination (6). The game apparatus 20 then transmits first guidance information to the server 10 (7). Specifically, based on the field on which the player character PC is located and the field on which the destination is located, the game apparatus 20 transmits either first guidance information A or first guidance information B.

The first guidance information A is information transmitted when the player character PC is located on a first field and the destination is set on the same first field. Specifically, the first guidance information A includes guidance voice identification information for specifying one of multiple first-type guidance voices. The first-type guidance voices are voices indicating the direction and distance to the destination, and include, for example, voices such as “Please proceed north. It is far away”, “Please proceed east. It is far away”, and “Please proceed southwest. It is close”. In addition to these voices, multiple first-type guidance voices indicating direction and distance are prepared in advance. Guidance voice data corresponding to these first-type guidance voices is stored in advance, for example, in the server 10.

The first guidance information B is information transmitted when the player character PC is located on a first field and the destination is set on a second field different from the first field. Specifically, the first guidance information B includes guidance voice identification information for specifying one of multiple second-type guidance voices. The second-type guidance voices are voices indicating the field of the destination and the direction to the destination, and include, for example, voices such as “The destination is in the sky field. Please proceed north”, “The destination is in the sky field. Please proceed east”, and “The destination is directly above here in the sky field”. In addition to these voices, multiple second-type guidance voices are prepared in advance. Guidance voice data corresponding to these second-type guidance voices is stored in advance, for example, in the server 10.

The field on which the player character PC is located is determined based on the position in the Y-axis direction of the player character PC. For example, when the Y-coordinate value of the player character PC is within a specified range in the up-down direction including the Y-coordinate value of the ground field GF, the player character PC is determined to be on the ground field GF. Also, when the Y-coordinate value of the player character PC is within a specified range in the up-down direction including the Y-coordinate value of the sky field SF, the player character PC is determined to be on the sky field SF.

When the server 10 receives the first guidance information from the game apparatus 20, the server 10 transmits second guidance information corresponding to the first guidance information, to the smartphone 30 (8). The second guidance information includes guidance voice data corresponding to the guidance voice identification information included in the first guidance information. The server 10 may transmit the first guidance information received from the game apparatus 20, to the smartphone 30, and the smartphone 30 may acquire the second guidance information corresponding to the received first guidance information, from the server 10.

The smartphone 30 then outputs voice guidance based on the guidance voice data received from the server 10 (9). As described above, the smartphone 30 updates the position of the icon IPC of the player character PC on the map image based on the position information of the player character PC periodically received from the server 10. In addition to (or instead of) the voice guidance, the smartphone 30 may output image guidance in the form of images or text.

Similarly, the game apparatus 20 calculates the direction and distance from the current position of the player character PC to the destination (10) again, and transmits the first guidance information to the server 10 again (11). The server 10 transmits the second guidance information corresponding to the first guidance information, to the smartphone 30 again. The smartphone 30 outputs voice guidance based on the second guidance information received again from the server 10 (13).

The game apparatus 20, the server 10, and the smartphone 30 repeatedly execute these processes at specified time intervals (for example, once every second or every few seconds). As a result, the content of the guidance changes in accordance with the current position of the player character PC. For example, when the player character PC is located on a field different from the field on which the destination is located, the smartphone 30 outputs voice guidance to the field on which the destination is located. When the player character PC has moved to the same field as the destination, voice guidance indicating the direction and distance to the destination in that field is output.

When the player character PC has reached the destination (for example, the position of the first game object 41 or a specified range including that position), the game apparatus 20 transmits an arrival notification indicating that the destination has been reached, to the server 10 (14). The server 10 transmits arrival voice data corresponding to the arrival notification, to the smartphone 30, and the smartphone 30 outputs a voice indicating the end of the guidance based on the received arrival voice data (15).

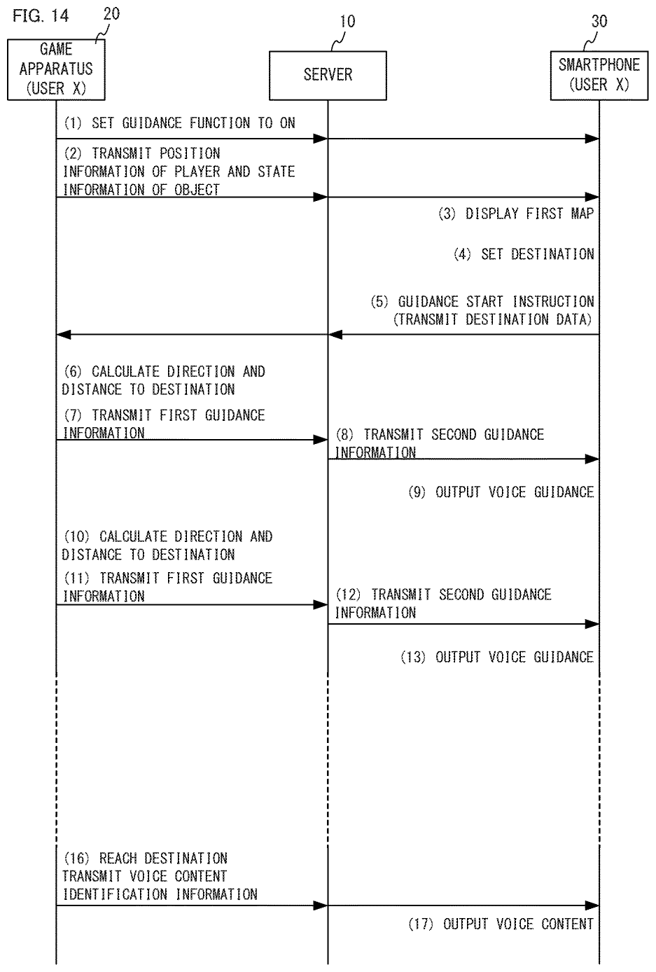

Next, an overview of the operation of each apparatus when guidance to a second game object 42 is performed will be described. FIG. 14 is a diagram showing an overview of the flow of the guidance to the second game object 42.

The second game object 42 is a game object related to a specific location and is, for example, an architectural object. The user selects one of the icons of the multiple second game objects 42 on the smartphone screen and sets the selected second game object 42 as a destination. When such a second game object 42 is set as the destination, guidance to the destination is performed through processes (1) to (13), in the same manner as the guidance to the first game object 41.

As shown in FIG. 14, when the player character PC has reached the position of the second game object 42 or a specified range including that position, the game apparatus 20 transmits voice content identification information to the server 10 (16). The voice content identification information is information for identifying specific voice data corresponding to a voice content related to the specific location. When the server 10 receives the voice content identification information, the server 10 transmits the specific voice data corresponding to the voice content identification information, to the smartphone 30. Then, the smartphone 30 outputs the voice content based on the specific voice data (17). The voice content is a voice related to the specific location and may include, for example, a voice describing an episode related to the specific location or a voice explaining the specific location. In addition to (or instead of) outputting the voice content, the smartphone 30 may display a video content including text or images related to the specific location.

As described above, in an exemplary embodiment, during execution of the game on the game apparatus 20, the smartphone 30 can perform guidance to the positions of game objects placed within the virtual space, such as items, characters, and architectural objects. Additionally, when guidance to the second game object 42 related to a specific location is provided, and the player character PC arrives at the position of the second game object 42, the smartphone 30 can output a voice content and/or video content related to that specific location.

### (Details of Processing in Game System)

Next, the details of processing in the game system 1 will be described. First, the data stored in the respective apparatuses included in the game system 1 will be described.

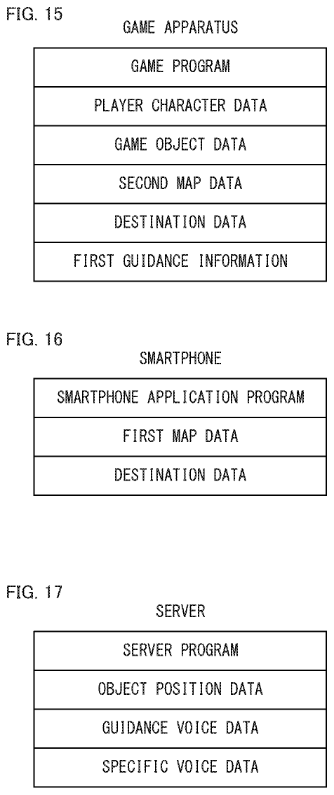

FIG. 15 shows an example of various data stored in the game apparatus 20. As shown in FIG. 15, a game program, player character data, game object data, second map data, destination data, and first guidance information are stored in the memory of the game apparatus 20 (for example, the DRAM 22, the dedicated memory card inserted into the slot, or the non-volatile memory 23).

The game program is a program for executing a game apparatus process (described later) executed in the game apparatus 20 and includes computer-executable instructions. The game program is stored in advance in the dedicated memory card or the non-volatile memory 23 and is loaded into the DRAM 22 when the game is to be executed.

The player character data is data regarding the player character PC and includes, for example, data indicating the shape and appearance of the player character PC, data indicating the position of the player character PC in the three-dimensional virtual space, and data indicating the orientation of the player character PC.

The game object data is data regarding each game object (items, characters, architectural objects, etc.) placed in the virtual space. The game object data includes, for example, data indicating the shape and appearance of each game object, data indicating the position of each game object in the three-dimensional virtual space. The game object data also includes the state information of each game object.

The second map data is data regarding the second map. The second map data includes map images corresponding to the respective fields. The second map data also includes information regarding multiple areas on each field (information indicating whether each area is in the opened state or the unopened state, and map information of the area, etc.)

The destination data is data regarding a destination that is set by the user using the smartphone 30. The destination data is, for example, the identification information of a game object that is set as the destination. The destination data is transmitted from the smartphone 30 via the server 10. The destination data may be the position information of the game object that is set as the destination.

The first guidance information includes guidance voice identification information for specifying the guidance voice data stored in the server 10.

FIG. 16 shows an example of various data stored in the smartphone 30. As shown in FIG. 16, a smartphone application program, first map data, and destination data are stored in the smartphone 30.

The smartphone application program is a program for executing a smartphone process (described later) executed in the smartphone 30 and includes computer-executable instructions. The smartphone application program is downloaded from the Internet and installed on the smartphone 30.

The first map data is data regarding the first map and includes map images corresponding to the respective fields. The first map data also includes data indicating the two-dimensional position of the icon IPC of the player character PC, and data indicating the two-dimensional position of the icon of each game object.

The destination data is data regarding the destination that is set by the user. For example, the destination data includes the identification information of the game object that is set as the destination.

FIG. 17 shows an example of various data stored in the server 10. As shown in FIG. 17, a server program, object position data, guidance voice data, and specific voice data are stored in the server 10.

The server program is a program for executing a server process (described later) executed in the server 10 and includes computer-executable instructions.

The object position data is data indicating the position (three-dimensional position) of each game object in the virtual space. In the game apparatus 20, the positions of the game objects may change from their initial positions. For example, a character automatically moves within a specified range including its initial position. In the server 10, the initial position of each game object is stored in advance.

The guidance voice data is voice data for outputting voice guidance to the destination. The specific voice data is voice data for outputting a voice content regarding a specific location.

### (Game Apparatus Process)

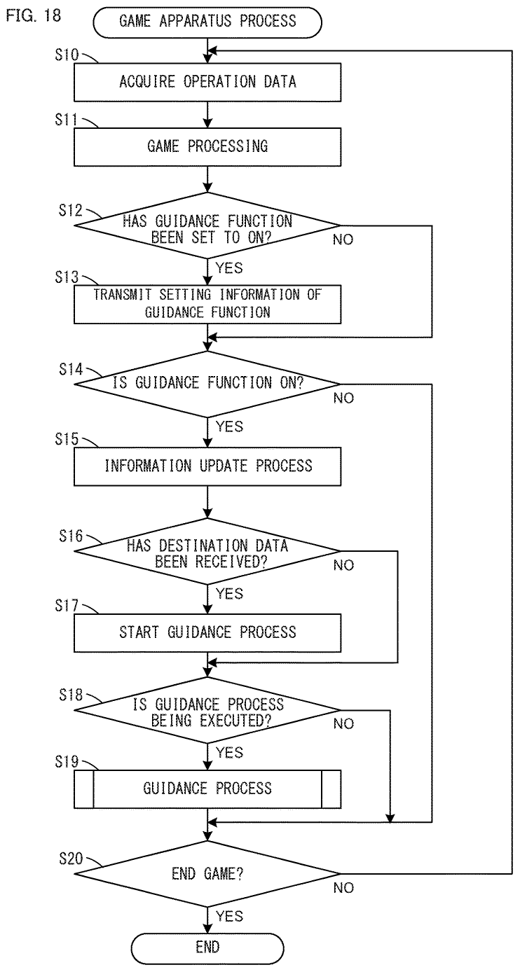

Next, the game apparatus process performed in the game apparatus 20 will be described. FIG. 18 is a flowchart showing an example of the game apparatus process performed in the game apparatus 20. The game apparatus process is started when an instruction to start the game is performed by the user.

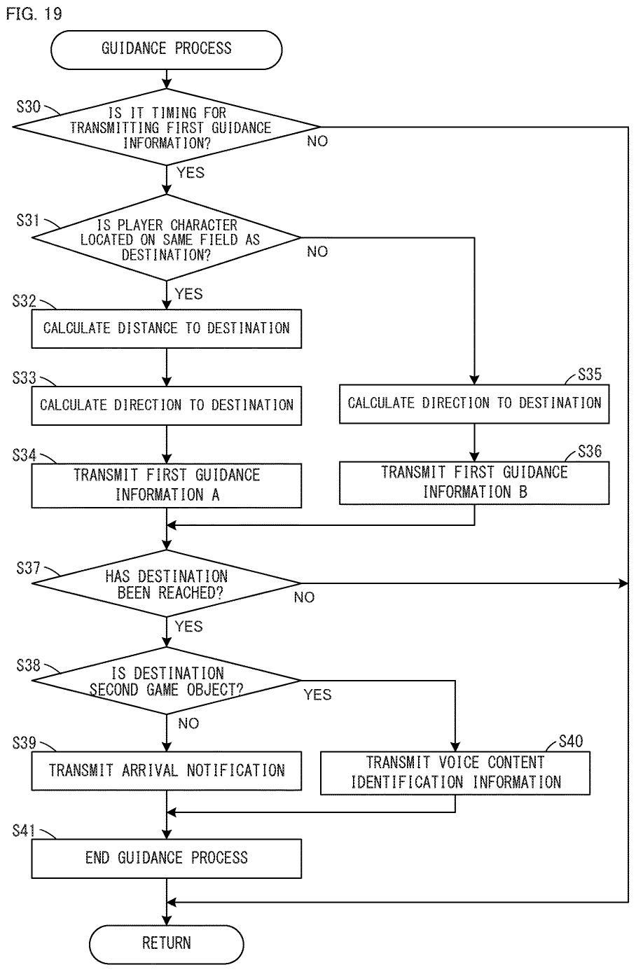

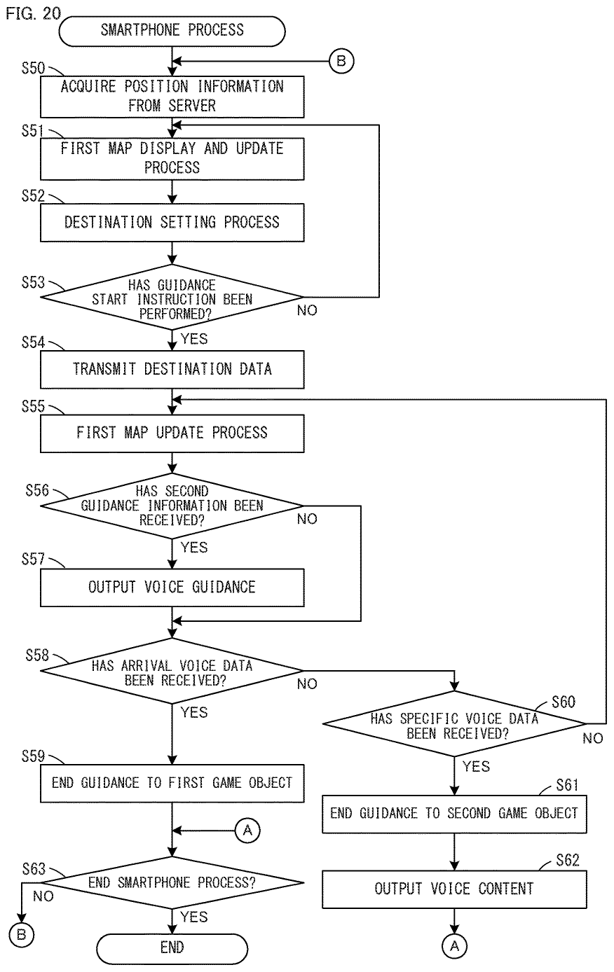

In an exemplary embodiment, description will be given assuming that the processor 21 of the game apparatus 20 executes the above game program using a memory (for example, the DRAM 22), thereby executing processes in steps shown in FIG. 18 and FIG. 19. However, in another exemplary embodiment, a processor different from the processor 21 (for example, a dedicated circuit or the like) may execute some of the processes in the steps. In addition, some of the processes in the steps may be executed in another information processing apparatus (for example, a server). The processes in the steps are merely examples, and the processing order of the steps may be changed, or another process may be executed in addition to (or instead of) the processes in the steps as long as similar results can be obtained.

As shown in FIG. 18, the processor 21 acquires operation data from the controller (step S10).

Next, the processor 21 performs game processing (step S11). For example, the processor 21 moves the player character PC within the virtual space based on the operation data. The processor 21 also causes the player character PC to perform a specified action based on the operation data. The processor 21 further moves characters placed in the virtual space according to a specified algorithm. In addition, when the player character PC is in a specified positional relationship with a game object in the virtual space, the processor 21 performs a process corresponding to the game object, based on the operation data. For example, when the player character PC is located in the vicinity of an item, the processor 21 causes the player character PC to acquire the item based on the operation data. The processor 21 also causes the player character PC to enter into combat with an enemy character or converse with an ally character located near the player character PC, based on the operation data. Further, when the player character PC reaches a certain game object and a specified operation is performed, the processor 21 sets the map information of the area related to that game object in the second map to the opened state. When an operation for displaying the second map is performed, the processor 21 displays the second map. The processor 21 generates a game image corresponding to the results of these processes and displays the game image on the display.

Next, the processor 21 determines whether or not the guidance function has been set to ON, based on the operation data (step S12).

If the guidance function has been set to ON (step S12: YES), the processor 21 transmits setting information of the guidance function to the server 10 (step S13). This setting information includes the account information of the user playing the game and the position information of the player character PC.

If the process in step S13 is executed, or if NO is determined in step S12, the processor 21 determines whether or not the guidance function is currently set to ON (step S14).

If the guidance function is set to ON (step S14: YES), the processor 21 performs an information update process (step S15). Here, the processor 21 transmits the position information of the player character PC updated in step S11, to the server 10. The processor 21 also transmits the state information of the game objects updated in step S11, to the server 10. The processor 21 executes the information update process in step S15 at intervals of one to several seconds.

Next, the processor 21 determines whether or not the destination data has been received from the server 10 (step S16). The destination data is transmitted when a destination is set in the smartphone 30 and a guidance start instruction is performed. If the destination data has been received (step S16: YES), the processor 21 starts a guidance process (step S17). Specifically, the processor 21 sets, as a destination, the three-dimensional position of the game object specified by the destination data, and sets a flag indicating that the guidance process is being executed, to ON.

If the process in step S17 is executed, or if NO is determined in step S16, the processor 21 determines whether or not the guidance process is being executed (step S18).

If the guidance process is being executed (step S18: YES), the processor 21 performs the guidance process (step S19). The details of the guidance process in step S19 will be described below.

### (Guidance Process)

FIG. 19 is a flowchart showing an example of the guidance process in step S19.

As shown in FIG. 19, the processor 21 determines whether or not it is a timing for transmitting the first guidance information (step S30). The processor 21 determines that it is the timing for transmitting the first guidance information, for example, at intervals of one to several seconds. If it is not the timing for transmitting the first guidance information (step S30: NO), the processor 21 ends the process in FIG. 19.

If it is the timing for transmitting the first guidance information (step S30: YES), the processor 21 determines whether or not the player character PC is on the same field as the destination (step S31).

If the player character PC is on the same field as the destination (step S31: YES), the processor 21 calculates the distance from the player character PC to the destination (step S32).

Next, the processor 21 calculates the direction from the player character PC to the destination (step S33). For example, the processor 21 calculates a vector from the position of the player character PC to the destination, calculates the angle between this vector and a predetermined direction (for example, the north direction), and determines the direction to the destination based on the calculated angle. For example, the processor 21 determines one of eight directions (north, northeast, east, southeast, south, southwest, west, and northwest) as the direction to the destination.

Then, based on the calculated direction and distance, the processor 21 transmits the first guidance information A to the server 10 (step S34). Specifically, based on the calculated direction and distance, the processor 21 transmits the first guidance information A including guidance voice identification information for specifying one of the multiple first-type guidance voices, to the server 10.

On the other hand, if the player character PC is not on the same field as the destination (step S31: NO), the processor 21 calculates the direction from the player character PC to the destination (step S35). For example, the processor 21 projects the position of the destination onto the field on which the player character PC is located, and calculates a vector from the position of the player character PC to the projected position of the destination. Then, the processor 21 calculates the angle between this vector and a predetermined direction (for example, the north direction), and determines the direction to the destination based on the calculated angle.

Then, the processor 21 transmits the first guidance information B to the server 10 (step S36). Specifically, based on the calculated direction and the field on which the destination is located, the processor 21 transmits the first guidance information B including guidance voice identification information for specifying one of the multiple second-type guidance voices, to the server 10.

If the process in step S34 is executed, or if the process in step S36 is executed, the processor 21 determines whether or not the player character PC has reached the destination (step S37). For example, if the player character PC is located within a specified range including the destination, the processor 21 determines that the player character PC has reached the destination.

If the player character PC has not reached the destination (step S37: NO), the processor 21 ends the process in FIG. 19.

If the player character PC has reached the destination (step S37: YES), the processor 21 determines whether or not the destination is the position of a second game object (step S38).

If the destination is not the position of a second game object (step S38: NO), the processor 21 transmits an arrival notification indicating the destination has been reached, to the server 10 (step S39).

On the other hand, if the destination is the position of a second game object (step S38: YES), the processor 21 transmits the voice content identification information corresponding to the second game object, to the server 10 (step S40).

If the process in step S39 has been executed, or if the process in step S40 is executed, the processor 21 ends the guidance process (step S41) and ends the process in FIG. 19.

Referring back to FIG. 18, if the process in step S19 is executed, if NO is determined in step S18, or if NO is determined in step S15, the processor 21 determines whether or not to end the game (step S20). For example, if an instruction to end the game is performed by the user, the processor 21 ends the game. If NO is determined in step S20, the processor 21 executes the process in step S10 again.

By repeatedly executing the processes in step S10 to step S20 at specified frame time intervals (for example, at intervals of 1/60 second), the game progresses. If the guidance function is set to ON, the first guidance information is repeatedly transmitted from the game apparatus 20 to the server 10 at time intervals of several to several tens of frames.

### (Smartphone Process)

Next, the smartphone process performed in the smartphone 30 will be described. FIG. 20 is a flowchart showing an example of the smartphone process performed in the smartphone 30. The process shown in FIG. 20 is started when the smartphone application of an exemplary embodiment is activated by the user.

As shown in FIG. 20, first, the smartphone 30 acquires position information from the server 10 (step S50). Specifically, the smartphone 30 acquires the two-dimensional position information of the player character PC and the two-dimensional position information of each game object placed on each field.

After acquiring the position information from the server 10, the smartphone 30 performs a first map display and update process (step S51). Specifically, based on the acquired position information, the smartphone 30 displays the map image corresponding to the field on which the player character PC is located, and places the icon IPC of the player character PC and the icons (I40 to I42) corresponding to the respective game objects, on the map image. The smartphone 30 updates the position of the icon IPC of the player character PC on the map image based on the position information periodically received from the server 10. The smartphone 30 may also update the display form of the icon of each game object based on the state information of each game object periodically received from the server 10. If any of the buttons “Ground”, “Sky”, and “Underground” is operated, the smartphone 30 displays the map image of the field associated with the operated button, and displays the icons corresponding to the game objects placed on that field.

Next, the smartphone 30 performs a destination setting process (step S52). Here, if the smartphone 30 receives an input from the user, and any one of a plurality of icons serving as destination candidates is selected, the smartphone 30 sets the game object corresponding to the selected icon, as a destination. A plurality of destinations may be set.

Next, the smartphone 30 determines whether or not a guidance start instruction has been performed (step S53). Specifically, the smartphone 30 determines whether or not the “Start Guidance” button has been operated.

If a guidance start instruction has not been performed (step S53: NO), the smartphone 30 executes the process in step S51 again.

If a guidance start instruction has been performed (step S53: YES), the smartphone 30 transmits the destination data to the server 10 (step S54). Specifically, the smartphone 30 transmits the identification information of the selected game object. The smartphone 30 may transmit the position information of the selected game object.

Next, the smartphone 30 performs a first map update process (step S55). The smartphone 30 updates the position of the icon IPC of the player character PC on the map image based on the position information of the player character PC periodically received from the server 10.

Next, the smartphone 30 determines whether or not the second guidance information has been received from the server 10 (step S56). The smartphone 30 may receive the second guidance information from the server 10 by receiving the first guidance information from the server 10 and transmitting, to the server 10, a request for transmitting the second guidance information corresponding to the first guidance information.

If second guidance information has been received (step S56: YES), the smartphone 30 outputs the voice guidance based on the guidance voice data included in the second guidance information (step S57).

If NO is determined in step S56, or if the process in step S57 is executed, the smartphone 30 determines whether or not the arrival voice data corresponding to the arrival notification transmitted in step S39 above has been received from the server 10 (step S58).

If the arrival voice data has been received (step S58: YES), the smartphone 30 outputs a voice indicating the end of the guidance, based on the voice data, and ends the guidance to the first game object (step S59). After the process in step S59, the smartphone 30 executes a process in step S63.

If the arrival voice data has not been received (step S58: NO), the smartphone 30 determines whether or not the specific voice data corresponding to the voice content identification information transmitted in step S40 above has been received from the server 10 (step S60).

If the specific voice data has been received (step S60: YES), the smartphone 30 ends the guidance to the second game object (step S61) and outputs a voice content based on the received specific voice data (step S62). After the process in step S62, the smartphone 30 executes the process in step S63.

If NO is determined in step S60, the smartphone 30 executes the process in step S55 again. By repeatedly executing the processes in step S55 to step S57 at specified time intervals, guidance to the destination is repeatedly output until the player character PC reaches the destination (first game object or second game object).

In step S63, the smartphone 30 determines whether or not to end the smartphone process. For example, the smartphone 30 determines whether or not an instruction to end the smartphone process has been performed by the user. If NO is determined in step S63, the smartphone 30 executes the process in step S50 again. If YES is determined in step S63, the smartphone 30 ends the smartphone process in FIG. 20.

### (Server Process)

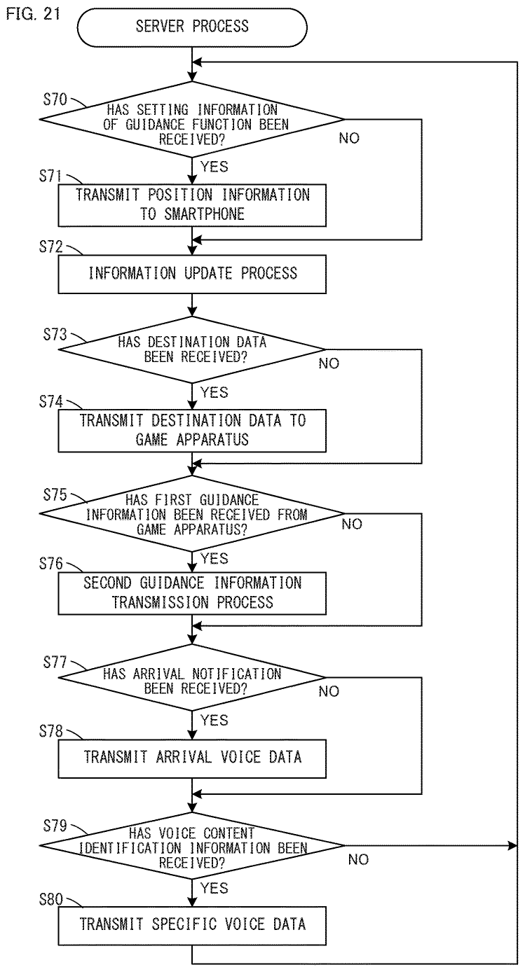

Next, the server process performed in the server 10 will be described. FIG. 21 is a flowchart showing an example of the server process performed in the server 10.

As shown in FIG. 21, the server 10 determines whether or not the setting information of the guidance function has been received from the game apparatus 20 (step S70).

If the setting information of the guidance function has been received (step S70: YES), the server 10 transmits position information to the smartphone 30 corresponding to the account of the game apparatus 20 that has transmitted the setting information (step S71). Specifically, the server 10 transmits the position information of the player character PC and the position information of each game object placed on each field, to the smartphone 30.

If NO is determined in step S70, or if the process in step S71 is executed, the server 10 performs an information update process (step S72). Here, based on the position information of the player character PC periodically transmitted from the game apparatus 20, the server 10 transmits the position information of the player character PC to the smartphone 30. The server 10 may also transmit the state information of each game object to the smartphone 30 based on the state information of each game object periodically transmitted from the game apparatus 20.

If NO is determined in step S70, or if the process in step S71 is executed, the server 10 determines whether or not the destination data has been received from the smartphone 30 (step S73).

If the destination data has been received (step S73: YES), the server 10 transmits the destination data to the game apparatus 20 (step S74).

If NO is determined in step S73, or if the process in step S74 is executed, the server 10 determines whether or not the first guidance information has been received from the game apparatus 20 (step S75).

If the first guidance information has been received (step S75: YES), the server 10 performs a second guidance information transmission process (step S76). Specifically, based on the first guidance information, the server 10 transmits the second guidance information including the guidance voice data specified by the guidance voice identification information, to the smartphone 30. The server 10 may transmit the first guidance information from the game apparatus 20, to the smartphone 30, and if a request for transmitting the second guidance information corresponding to the first guidance information is received from the smartphone 30, the server 10 may transmit the second guidance information to the smartphone 30.

If NO is determined in step S75, or if the process in step S76 is executed, the server 10 determines whether or not an arrival notification indicating that the destination has been reached has been received from the game apparatus 20 (step S77).

If the arrival notification has been received (step S77: YES), the server 10 transmits the arrival voice data indicating that the destination has been reached, to the smartphone 30 (step S78).

If NO is determined in step S77, or if the process in step S78 is executed, the server 10 determines whether or not the voice content identification information has been received from the game apparatus 20 (step S79).

If the voice content identification information has been received (step S79: YES), the server 10 transmits the specific voice data corresponding to the voice content identification information, to the smartphone 30 (step S80). The server 10 may transmit the voice content identification information from the game apparatus 20, to the smartphone 30, and if a request for transmitting the specific voice data corresponding to the voice content identification information is received from the smartphone 30, the server 10 may transmit the specific voice data to the smartphone 30.

If NO is determined in step S79, or if the process in step S80 is executed, the server 10 executes the process in step S70 again. This is the end of the description of FIG. 21.

The processes shown in the above flowcharts are merely illustrative, and the order, contents, etc., of the processes may be changed as appropriate.

As described above, the game system of the present embodiment includes a game apparatus and a communication terminal (for example, a smartphone) each capable of communicating with a server. The game apparatus performs movement control for moving a player character within a three-dimensional virtual space, based on an operation input. The communication terminal includes a display and a speaker, stores a two-dimensional first map corresponding to the three-dimensional virtual space, displays the first map and destination point candidates on a display, determines a destination point from among the candidates based on an operation input, and transmits the determined destination point to the server. The game apparatus acquires the destination point from the server, calculates, based on a destination in the three-dimensional virtual space corresponding to the destination point acquired from the server and three-dimensional position information of the player character within the three-dimensional virtual space, a distance or direction from the player character to the destination, determines first guidance information based on the calculated distance or direction from the player character to the destination, and transmits the first guidance information to the server. The communication terminal acquires the first guidance information or second guidance information corresponding to the first guidance information, from the server, and outputs a guidance display from the display or a guidance voice from a speaker based on the first guidance information or the second guidance information acquired from the server.

Accordingly, the user can set a destination using the first map displayed on the communication terminal, and by operating the game apparatus based on the guidance display or guidance voice from the communication terminal, can cause the player character to reach the destination.

In an exemplary embodiment, the three-dimensional virtual space includes a first field and a second field located above or below the first field. The first map includes a map indicating map information of the first field and a map indicating map information of the second field, and the communication terminal determines the destination point on the first field or the second field based on an operation input. The communication terminal outputs, as the guidance display or the guidance voice, first guidance indicating a distance or direction to the destination, if the destination is on the first field when the player character is located on the first field, and outputs, as the guidance display or the guidance voice, second guidance indicating that the destination is on the second field, if the destination is on the second field when the player character is located on the first field.

Accordingly, if the destination is on a field different from the field on which the player character is located, guidance to the field can be performed, and if the destination is on the field on which the player character is located, specific guidance to the destination can be performed.

In an exemplary embodiment, the game apparatus stores a two-dimensional second map corresponding to the first map and indicating map information of a field in the three-dimensional virtual space, displays the second map in a first state including first map information or the second map in a second state not including the first map information, based on an operation input, and changes the second map from the second state to the first state in accordance with the player character reaching the destination or a specified condition being satisfied at the destination (for example, a specified action being performed). The first map includes second map information corresponding to the first map information of the second map regardless of whether the second map is in the first state or the second state. The communication terminal displays the first map including the second map information and position information of the player character, on the display.

Even in a state where the second map displayed on the game apparatus does not include map information, guidance to the destination can be performed using the communication terminal.

In an exemplary embodiment, the communication terminal determines a second-type destination point from the candidates based on an operation input, and transmits the determined second-type destination point to the server. The game apparatus acquires the second-type destination point from the server, and transmits identification information corresponding to the second-type destination, to the server if the player character reaches a second-type destination in the three-dimensional virtual space corresponding to the second-type destination point acquired from the server. The communication terminal outputs a voice content corresponding to the identification information, from the speaker.

Since the voice content corresponding to the second-type destination is output when the player character reaches the second-type destination, the user can be provided with a sense of enjoyment upon reaching the destination.

### (Modifications)

While an exemplary embodiment has been described above, the above exemplary embodiments are merely an example, and the following modifications may be made, for example.

For example, in the above embodiment, the game apparatus 20 calculates the direction and distance from the player character PC to the destination, and, based on the calculated direction and distance, transmits information for specifying guidance voice data as the first guidance information to the server 10. The server 10 transmits the second guidance information (guidance voice data) based on the first guidance information, to the smartphone 30, and the smartphone 30 outputs the guidance voice based on the guidance voice data.

In another exemplary embodiment, the game apparatus 20 may transmit the first guidance information to the server 10, and the server 10 may transmit the first guidance information directly to the smartphone 30. Then, the smartphone 30 may reproduce the guidance voice data based on the first guidance information, thereby outputting a guidance voice indicating the direction and distance from the position of the player character PC to the destination.

In another exemplary embodiment, the game apparatus 20 may transmit, as the first guidance information, information indicating the direction and distance from the player character PC to the destination, and the server 10 may transmit the information indicating the direction and distance and received from the game apparatus 20, directly to the smartphone 30. Then, the smartphone 30 may receive this information from the server 10 and reproduce the guidance voice data based on the information.

In another exemplary embodiment, the game apparatus 20 may transmit, as the first guidance information, information indicating the direction and distance from the player character PC to the destination, and the server 10 may transmit the guidance voice data to the smartphone 30 based on the information indicating the direction and distance and received from the game apparatus 20. Then, the smartphone 30 may reproduce the received guidance voice data, thereby outputting a guidance voice indicating the direction and distance from the position of the player character PC to the destination.

In another exemplary embodiment, the game apparatus 20 may transmit, as the first guidance information, information indicating the direction and distance from the player character PC to the destination, and the server 10 may transmit the guidance voice identification information for specifying the guidance voice data to the smartphone 30 based on the information indicating the direction and distance and received from the game apparatus 20. The smartphone 30 may store the guidance voice data corresponding to the guidance voice identification information and reproduce the guidance voice data corresponding to the received guidance voice identification information.

In another exemplary embodiment, the game apparatus 20 may calculate the direction and distance from the position of the player character PC to the destination and transmit the guidance voice data based on the calculated direction and distance, to the server 10. The server 10 may transmit the guidance voice data to the smartphone 30, and the smartphone 30 may reproduce the received guidance voice data.

In another exemplary embodiment, the game apparatus 20 may repeatedly transmit the position of the player character PC to the server 10 at predetermined time intervals, and the server 10 may calculate the direction and distance to the destination based on the position of the player character PC and transmit information indicating the direction and distance, to the smartphone 30. The smartphone 30 may output a guidance voice based on the received information indicating the direction and distance.

In another exemplary embodiment, the game apparatus 20 may repeatedly transmit the position of the player character PC to the server 10 at specified time intervals, and the server 10 may transmit the received position to the smartphone 30. The smartphone 30 may calculate the direction and distance to the destination based on the position of the player character PC and output a guidance voice based on the calculated direction and distance.

In the above embodiment, the game apparatus 20 determines whether or not the player character PC has reached the destination, based on the position of the player character PC and the destination. In another exemplary embodiment, the smartphone 30 may determine whether or not the player character PC has reached the destination, based on the position of the player character PC and the destination.

In the above embodiment, the server 10 stores the specific voice data corresponding to a voice content, transmits the specific voice data to the smartphone 30, and the smartphone 30 outputs the voice content based on the received specific voice data. In another exemplary embodiment, the specific voice data corresponding to the voice content may be stored in advance in the smartphone 30. If the player character PC reaches the second game object 42, the game apparatus 20 may transmit the identification information (voice content identification information) corresponding to the second game object 42, to the server 10, the server 10 may transmit the identification information to the smartphone 30, and the smartphone 30 may reproduce the specific voice data corresponding to the identification information.

In another exemplary embodiment, the specific voice data corresponding to the voice content may be stored in advance in the game apparatus 20, and if the player character PC reaches the second game object 42, the game apparatus 20 may transmit the identification information (specific voice data) corresponding to the second game object 42, to the server 10, the server 10 may transmit the identification information (specific voice data) to the smartphone 30, and the smartphone 30 may receive the identification information and output the voice content.

In the above embodiment, if guidance to the second game object 42 related to a specific location is performed, and the player character PC reaches the position of the second game object 42, the smartphone 30 outputs the voice content related to the specific location. In another exemplary embodiment, when guidance to the second game object 42 is not being performed, if the player character PC reaches the position of the second game object 42, the smartphone 30 may output the voice content related to the specific location. For example, when the smartphone 30 is performing guidance to the first game object 41, if the player character PC reaches the position of the second game object 42, the smartphone 30 may end the guidance to the first game object 41 and output the voice content related to the specific location.

In the above embodiment, the game apparatus 20 and the smartphone 30 are each connected to the Internet and communicate with the server 10. In another exemplary embodiment, the game apparatus 20 and the smartphone 30 may communicate with each other directly or indirectly not via the server 10.

In the above embodiment, a destination is set by selecting one of a plurality of destination candidates (icons) superimposed on the map image on the application screen. The method for setting a destination is merely an example and is not limited to the above method. For example, the destination candidates may be displayed in a list on the application screen, and the user may set a destination by selecting one of the destination candidates in the list.

In the above embodiment, a game object is set as a destination. In another exemplary embodiment, the user may specify any position on the map image on the application screen (any position on a field), thereby setting the specified position as a destination.

Some of the processes performed in the respective apparatus (the game apparatus, the server, and the smartphone) included in the game system described above may be performed in another apparatus.

The examples according to the above embodiments and the modifications thereof may be combined together as desired as long as the examples do not contradict each other. The above is merely an example of the exemplary embodiments, and various modifications and variations may be made.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A game system comprising a game apparatus and a communication terminal including a display and a speaker, wherein
the game apparatus is configured to perform movement control for moving a player character within a three-dimensional virtual space, based on an operation input,
the communication terminal is configured to
store a two-dimensional first map corresponding to the three-dimensional virtual space,
display the first map and destination point candidates on the display,
determine a destination point from among the candidates based on an operation input, and
transmit the determined destination point to a server,
the game apparatus is further configured to
acquire the destination point from the server,
calculate, based on a destination in the three-dimensional virtual space corresponding to the destination point acquired from the server and three-dimensional position information of the player character within the three-dimensional virtual space, a distance or direction from the player character to the destination,
determine first guidance information based on the calculated distance or direction from the player character to the destination, and
transmit the first guidance information to the server,
the communication terminal is further configured to
acquire the first guidance information or second guidance information corresponding to the first guidance information, from the server, and
output a guidance display from the display or a guidance voice from the speaker based on the first guidance information or the second guidance information acquired from the server.

2. The game system according to claim 1, wherein
the three-dimensional virtual space includes a first field and a second field located above or below the first field, and
the first map includes a map indicating map information of the first field and a map indicating map information of the second field.

3. The game system according to claim 2, wherein
the communication terminal is configured to
determine the destination point on the first field or the second field based on an operation input,
output, as the guidance display or the guidance voice, first guidance indicating a distance or direction to the destination, if the destination is on the first field when the player character is located on the first field, and
output, as the guidance display or the guidance voice, second guidance indicating that the destination is on the second field, if the destination is on the second field when the player character is located on the first field.

4. The game system according to claim 1, wherein
the game apparatus is configured to
store a two-dimensional second map corresponding to the first map and indicating map information of a field in the three-dimensional virtual space,
display the second map in a first state including first map information or the second map in a second state not including the first map information, based on an operation input, and
change the second map from the second state to the first state in accordance with the player character reaching the destination or a specified condition being satisfied at the destination,
the first map includes second map information corresponding to the first map information of the second map regardless of whether the second map is in the first state or the second state, and
the communication terminal is configured to
display the first map including the second map information and position information of the player character, on the display.

5. The game system according to claim 1, wherein
the communication terminal is configured to
determine a second-type destination point from the candidates based on an operation input, and
transmit the determined second-type destination point to the server,
the game apparatus is configured to
acquire the second-type destination point from the server, and
transmit identification information corresponding to the second-type destination, to the server if the player character reaches a second-type destination in the three-dimensional virtual space corresponding to the second-type destination point acquired from the server, and
the communication terminal is configured to
output a voice content corresponding to the identification information, from the speaker.

6. The game system according to claim 5, wherein
the game apparatus is configured to
calculate a distance or direction from the player character to the second-type destination in the three-dimensional virtual space based on the second-type destination and the position information,
determine the first guidance information based on the calculated distance or direction from the player character to the second-type destination, and
transmit the first guidance information to the server.

7. The game system according to claim 1, wherein
the communication terminal is configured to
acquire voice data as the second guidance information, and
output the guidance voice based on the acquired voice data.

8. An information processing method performed in a game system including a game apparatus and a communication terminal including a display and a speaker, the information processing method comprising:
in the game apparatus,
performing movement control for moving a player character within a three-dimensional virtual space, based on an operation input;
in the communication terminal,
displaying a two-dimensional first map corresponding to the three-dimensional virtual space and destination point candidates on the display,
determining a destination point from among the candidates based on an operation input, and
transmitting the determined destination point to a server;
in the game apparatus,
acquiring the destination point from the server,
calculating, based on a destination in the three-dimensional virtual space corresponding to the destination point acquired from the server and three-dimensional position information of the player character within the three-dimensional virtual space, a distance or direction from the player character to the destination,
determining first guidance information based on the calculated distance or direction from the player character to the destination, and
transmitting the first guidance information to the server; and
in the communication terminal,
acquiring the first guidance information or second guidance information corresponding to the first guidance information, from the server, and
outputting a guidance display from the display or a guidance voice from the speaker based on the first guidance information or the second guidance information acquired from the server.

9. The information processing method according to claim 8, wherein
the three-dimensional virtual space includes a first field and a second field located above or below the first field, and
the first map includes a map indicating map information of the first field and a map indicating map information of the second field.

10. The information processing method according to claim 9, further comprising
in the communication terminal,
determining the destination point on the first field or the second field based on an operation input,
outputting, as the guidance display or the guidance voice, first guidance indicating a distance or direction to the destination, if the destination is on the first field when the player character is located on the first field, and
outputting, as the guidance display or the guidance voice, second guidance indicating that the destination is on the second field, if the destination is on the second field when the player character is located on the first field.

11. The information processing method according to claim 8, further comprising
in the game apparatus,
displaying a two-dimensional second map in a first state including first map information or the two-dimensional second map in a second state not including the first map information, based on an operation input, the second map corresponding to the first map and indicating map information of a field in the three-dimensional virtual space, and
changing the second map from the second state to the first state in accordance with the player character reaching the destination or a specified condition being satisfied at the destination, wherein
the first map includes second map information corresponding to the first map information of the second map regardless of whether the second map is in the first state or the second state, and
the information processing method further comprises, in the communication terminal,
displaying the first map including the second map information and position information of the player character, on the display.

12. The information processing method according to claim 8, further comprising:
in the communication terminal,
determining a second-type destination point from the candidates based on an operation input, and
transmitting the determined second-type destination point to the server;
in the game apparatus,
acquiring the second-type destination point from the server, and
transmitting identification information corresponding to the second-type destination, to the server if the player character reaches a second-type destination in the three-dimensional virtual space corresponding to the second-type destination point acquired from the server; and
in the communication terminal,
outputting a voice content corresponding to the identification information, from the speaker.

13. The information processing method according to claim 12, further comprising
in the game apparatus,
calculating a distance or direction from the player character to the second-type destination in the three-dimensional virtual space based on the second-type destination and the position information,
determining the first guidance information based on the calculated distance or direction from the player character to the second-type destination, and
transmitting the first guidance information to the server.

14. The information processing method according to claim 8, further comprising
in the communication terminal,
acquiring voice data as the second guidance information, and
outputting the guidance voice based on the acquired voice data.

15. One or more non-transitory computer-readable media having stored therein instructions that, when executed, cause one or more processors of a game apparatus to perform operations comprising:
performing movement control for moving a player character within a three-dimensional virtual space, based on an operation input in the game apparatus;
acquiring, from a server, a destination point determined in a communication terminal based on an operation input;
calculating, based on a destination in the three-dimensional virtual space corresponding to the destination point acquired from the server and three-dimensional position information of the player character within the three-dimensional virtual space, a distance or direction from the player character to the destination;
determining first guidance information for outputting a guidance display or a guidance voice in the communication terminal, based on the calculated distance or direction from the player character to the destination; and
transmitting the first guidance information to the server.
